(19) United States
(12) Patent Application Publication
(10) Pub. No.: US 2008/0154880 A1
(43) Pub. Date: Jun. 26, 2008

(54) Method of displaying listed result of internet-based search

(75) Inventor: Chung-Hung Hsu, Taichung City (TW)

Correspondence Address: BACON & THOMAS, PLLC, 625 SLATERS LANE, FOURTH FLOOR, ALEXANDRIA, VA, 22314, US

(73) Assignee: GU TA INTERNET INFORMATION CO., LTD., TAICHUNG CITY (TW)

(21) Appl. No.: 11/730,814

(22) Filed: Apr. 4, 2007

(30) Foreign Application Priority Data
Dec. 26, 2006 (TW) 95149059

(51) Int. Cl. G06F 17/30

(52) U.S. Cl. 707/5; 707/E17.108

(57) ABSTRACT

A method of displaying a listed result of an internet-based search includes the steps of inputting at least one keyword in a searchable website connected to a searchable database at least having a plurality of URLs and corresponding displayed information and at least one image; comparing the at least one keyword with the searchable database according to a first predetermined condition to locate the URLs matching the first predetermined condition; ranking the matched URLs according to a second predetermined condition and capturing each displayed information corresponding to the URL to generate a list having a plurality of columns containing the displayed information of each URL; and displaying the list on one web page. Each of the displayed information contains a hyperlink of an URL and the corresponding displayed information and image.

### BACKGROUND OF THE INVENTION

1. Field of the Invention

The present invention relates generally to internet-based searching technology, and more particularly, to a method of displaying a listed result of an internet-based search.

2. Description of the Related Art

When a user intends to search something on an internet search web site, like Yahoo! or Google, the user can first input the desired keyword into the web site for searching. When the server performs this searching, it compares this keyword with a great amount of data therein, and then ranks the matched URLs (uniform resource locator) according to degree of similarity, and finally lists the URLs one by one on another web page.

So far, when the conventional search is applied and the result is shown, for each URL, the result usually lists the hyperlink of the URL that the keyword is located and a part of literal description located beside the URL. Thus, when browsing the search result, the general user sees a mass of words and usually has little patience to read the literal description beside the hyperlink of each URL. Fewer users will click on the next page to see more words.

Therefore, how to enable the search result to be read rapidly and enable the user to rapidly decide whether the hyperlink of the URL is worth clicking for further reading is the subject matter of the present invention.

### SUMMARY OF THE INVENTION

The primary objective of the present invention is to provide a method of displaying a listed result of an internet-based search, which enables the listed result to be reader-friendly.

The secondary objective of the present invention is to provide a method of displaying a listed result of an internet-based search, which puts corresponding images in the search result to facilitate the user's prompt identification.

The foregoing objectives of the present invention are attained by the method includes the steps of inputting at least one keyword in a searchable website connected to a searchable database at least having a plurality of URLs and corresponding displayed information and at least one image; comparing the at least one keyword with the searchable database according to a first predetermined condition to locate the URLs matching the first predetermined condition; ranking the matched URLs according to a second predetermined condition and capturing each displayed information corresponding to the URL to generate a list having a plurality of columns containing the displayed information of each URL; and displaying the list on one web page. Each of the displayed information contains a hyperlink of an URL and the corresponding displayed information and image. In light of this, during the search, the method not only compares the keyword but also captures the corresponding displayed information containing the image to show it on the web page, thus facilitating the user to rapidly identify and to easily read the search result.

### BRIEF DESCRIPTION OF THE DRAWINGS

FIG. 1 is a flowchart of a preferred embodiment of the present invention.

FIG. 2 is a schematic view of the preferred embodiment of the present invention in operation.

FIG. 3 is a schematic view of the preferred embodiment of the present invention, illustrating the structure of the searchable database.

FIG. 4 is a schematic view of the preferred embodiment of the present invention, illustrating the structure of the displayed information.

FIG. 5 is a schematic view of the preferred embodiment of the present invention, illustrating the listed search result after operation.

### DETAILED DESCRIPTION OF PREFERRED EMBODIMENTS

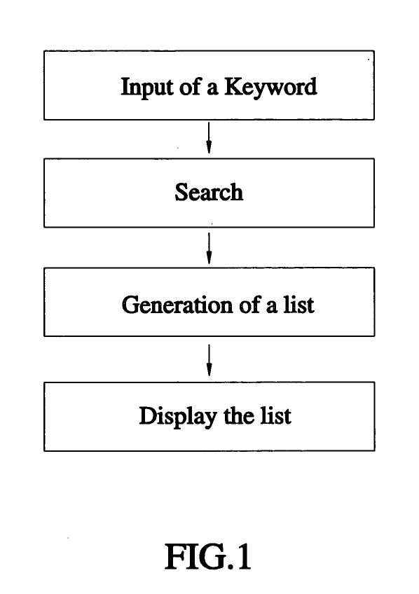

Referring to FIGS. 1-5, a method of displaying a listed result of an internet-based search, based on a preferred embodiment of the present invention, includes the following steps.

A. Input of a Keyword:

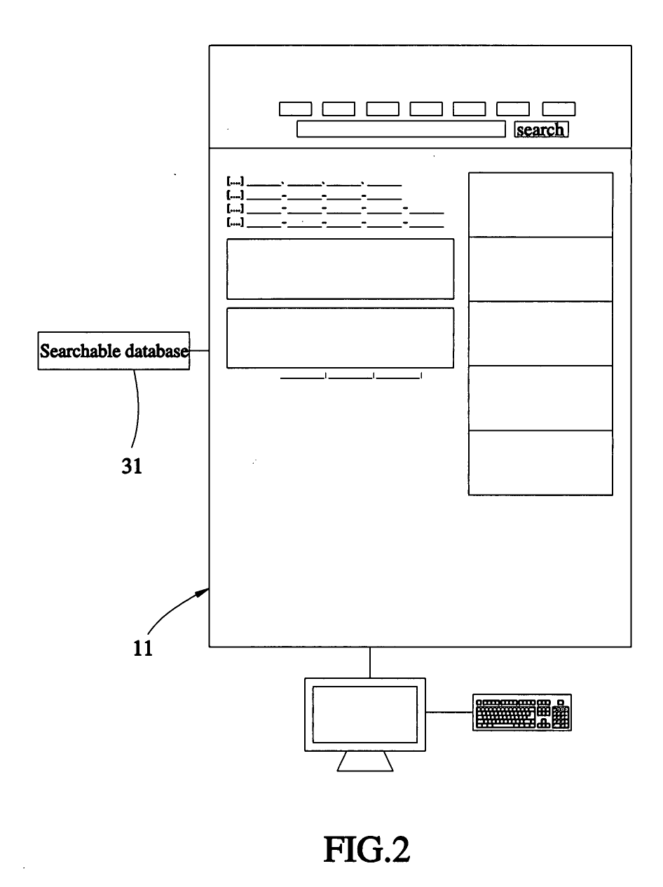

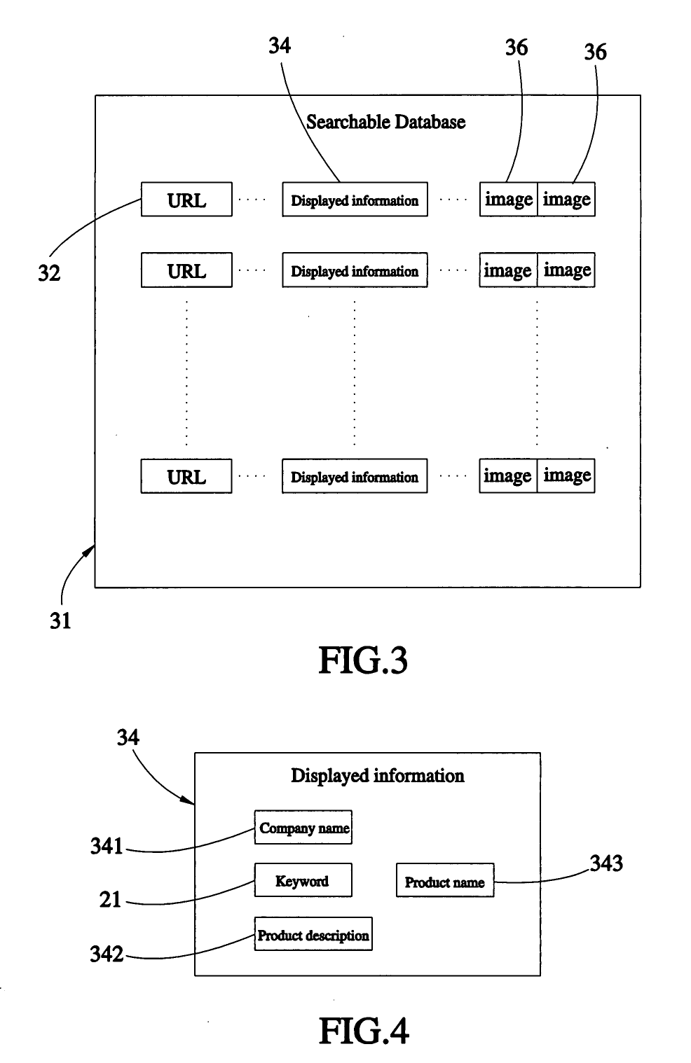

Input at least one keyword 21 in a searchable web page 11 (FIG. 2). The web page 11 is connected to a searchable database 31. The database 31 contains a plurality of URLs 32, and displayed information 34 and two images 36 corresponding to each URL 32. One of the two images 36 shows the trademark of a company that the URL 32 indicates and the other image 36 shows the photograph of a product of the company. The displayed information 34 contains a company name 341, the keyword 21, and a product description 342, or a plurality of product names 343. The searchable database 31 and the displayed information 34 are shown in FIGS. 3 and 4 respectively.

B. Search:

Compare the keyword 21 with the database 31 according to a first predetermined condition to locate the URLs 32 matching the first predetermined condition. In this embodiment, the first predetermined condition contains the degree of similarity of character between the keyword 21 and the product name 343, or the degree of similarity of character of the company name, or the degree of similarity of character of the product category.

C. Generation of a List:

Rank the above matched URLs 32 according to a second predetermined condition and capture the displayed information corresponding to each of the URLs 32 to generate a list 41. In this embodiment, the second predetermined condition contains the degree of similarity of the product name 343, or the hit rate, or the amount of payment, or the time spent. In light of the condition, the ranking of the URLs 32 can be done.

D. Display of the List:

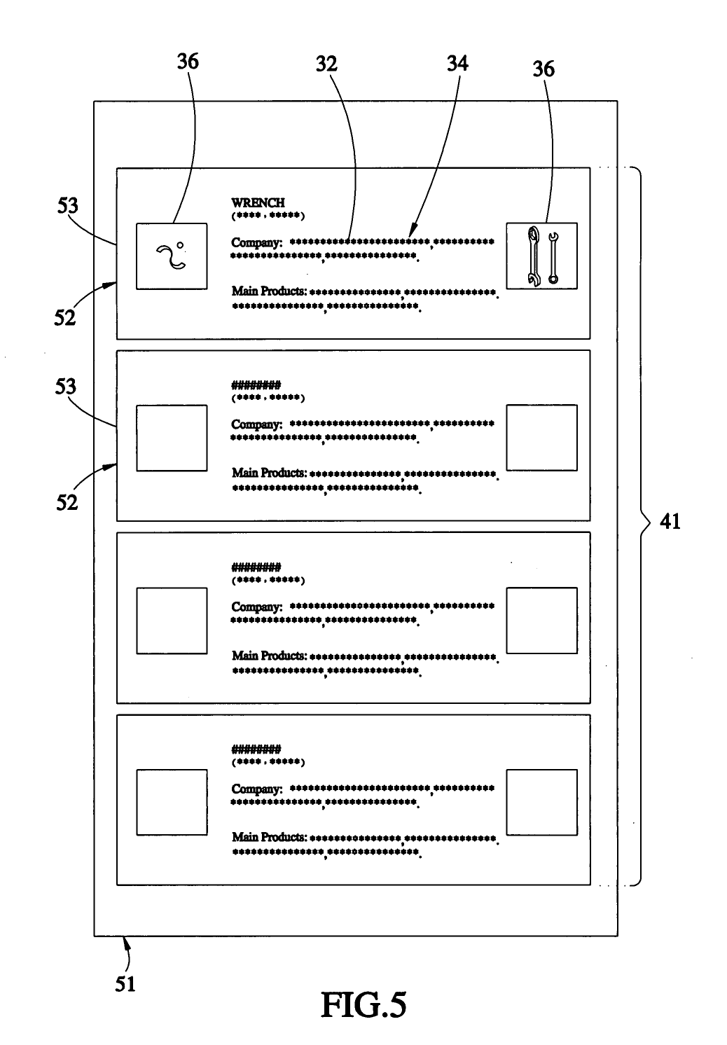

Display the list 41 on a web page 51 as shown in FIG. 5. A plurality of columns 52 are located on the web page 51 and each contain a frame boarder 53. Each of the columns 52 contains a hypertext having one of the URLs 32 therein and the displayed information 34 and images 36 corresponding to the URL 32. The text in the hypertext can be the company name. One of the images 36, i.e. company trademark, is shown at the left side of the displayed information 34 and the other image 36, i.e. product photograph, is shown at the right side of the displayed information.

In light of the above steps, the images 36 in connection with the hypertext of the URL 32 can be clearly viewed from the list 41, and further, the user can clearly view the company trademark and product photograph from the images 36. When browsing the list, the user can learn the content of the hypertext of the URL 32 corresponding to the company name in the column 52 from the displayed information 34 or instinctively view the information that the hypertext is linked of the corresponding URL 32 from the two images 36 (the company trademark and the product photograph).

As shown above, the present invention facilitates the user to rapidly browse the listed search result on the website to enable the search result to be reader-friendly. Furthermore, the additional images (the company trademark and the product photograph) included in the listed search result can enable the user for rapid identification.

Although the present invention has been described with respect to a specific preferred embodiment thereof, it is no way limited to the details of the illustrated structures but changes and modifications may be made within the scope of the appended claims.

What is claimed is:

1. A method of displaying a listed result of an internet-based search, comprising steps of:
inputting at least one keyword in a searchable web page connected to a searchable database at least having a plurality of URLs (uniform resource locator) and corresponding displayed information and at least one image;
comparing said at least one keyword with said database according to a first predetermined condition to locate said URLs matching said first predetermined condition;
ranking said matched URLs according to a second predetermined condition and capturing said displayed information corresponding to each of said matched URLs to generate a list; and
displaying said list on a web page having a plurality of columns, wherein each of said columns has a hypertext of one of said matched URLs and said corresponding displayed information and image.

2. The method as defined in claim 1, wherein said displayed information at least comprises a company name, said at least one keyword, and a product description.

3. The method as defined in claim 1, wherein said at least one image is a company trademark.

4. The method as defined in claim 1, wherein said at least one image is a product photograph.

5. The method as defined in claim 1, wherein said first predetermined condition comprises a degree of similarity of character between said at least one keyword and a product name.

6. The method as defined in claim 1, wherein said second predetermined condition comprises a degree of similarity of character of a product name, a hit rate, an amount of payment, or the time spent.

7. The method as defined in claim 1, wherein each of said columns is provided with a frame boarder.

8. The method as defined in claim 1, wherein said at least one image is located beside said displayed information.
